(19) United States
(12) Patent Application Publication
(10) Pub. No.: US 2012/0256714 A1
(43) Pub. Date: Oct. 11, 2012

(54) PNEUMATICALLY DAMPED RELAY

(75) Inventors: Sven Hartmann, Stuttgart (DE); Martin Mezger, Stuttgart (DE); Thomas Erler, Stuttgart (DE)

(73) Assignee: ROBERT BOSCH GMBH, Stuttgart (DE)

(21) Appl. No.: 13/499,742

(22) PCT Filed: Sep. 29, 2010
(86) PCT No.: PCT/EP2010/064481

§ 371 Date: Jun. 21, 2012

(30) Foreign Application Priority Data
Oct. 1, 2009 (DE) 10 2009 045 262.1

(51) Int. Cl. H01H 9/00; H01H 51/06

(52) U.S. Cl. 335/203

(57) ABSTRACT

The invention relates to a relay (16), especially for electrical starting devices for internal combustion engines. The relay (16) comprises a relay armature (168) and an armature return element (171). A fluid, enclosed in a hollow space (236, Δs), between the relay armature (168) and the armature return element (171) pneumatically damps the collision between the relay armature (168) and the armature return element (171).

### BACKGROUND OF THE INVENTION

DE 101 24 506 A1 relates to a starter for a motor vehicle. The starter comprises a pole housing which contains the starter motor, an engagement relay which is arranged parallel to said pole housing and contains a solenoid switch, an engagement lever, which is rotatably mounted with a transition region between the pole housing and the engagement relay, for coupling the starter motor to the internal combustion engine. A seal to prevent the ingress of contaminants and moisture into the engagement relay is also provided. The seal is formed by a rubber diaphragm, which is connected to the housing walls, within the transition region between the pole housing and the engagement relay.

DE 195 49 179 A1 relates to an engagement relay for a starter apparatus. The engagement relay comprises a contact bridge which bridges at least two contact pins in the switched-on state and which is fitted to a moving switching spindle. The contact bridge has in each case at least two defined contact areas which are associated with one contact pin and which are provided on spring arms which are flexible in their longitudinal extent and transverse to their longitudinal extent.

Whereas approximately 40 000 starting processes are completed over the service life of a vehicle in conventional electrical starting apparatuses for internal combustion engines, up to half a million and more switching processes are carried out in starters which are employed in internal combustion engines with a start/stop functionality. This means that the electrical starting apparatus has to be correspondingly designed.

The electrical starting apparatus accordingly has to be designed for such a high number of switching cycles and complete these without problems. It has been found that relatively high demands are made of the acoustics of the electrical starting apparatus in passenger cars which are equipped with a start/stop functionality. Noises which are produced by metal elements being struck in the components of a starter, in particular an electrical starting apparatus, are found to cause discomfort and to be disturbing.

### SUMMARY OF THE INVENTION

In order to reduce the noise level when operating an electrical starting apparatus, the invention proposes pneumatically providing pneumatic damping between components which move relative to one another, in particular a linearly moving relay armature and an armature return. When power is supplied to the magnet coils of the relay of an electrical starting apparatus, the relay armature which is displaceably guided in the relay housing moves toward an armature return which is arranged in a stationary manner in the relay. Both the end faces of the relay armature which moves relative to the armature return and those of the armature return have a mutually complementary geometric contour and form a hollow space which is filled with a fluid, in particular air.

By virtue of providing suitable sealing measures, for example providing a V-shaped sealing lip or a sealing ring which is fitted to the casing surface of the relay armature which moves relative to the relay housing, the volume of fluid which remains in the hollow space between the relay armature and the armature return is sealed off to prevent losses, that is to say leakage, and therefore the volume of fluid can be used as a fluid cushion for damping the stopping movement of the end face of the relay armature against the corresponding end face of the armature return, it being possible for this to be used to drastically reduce the momentum of the moving relay armature and accordingly to reduce its energy. Examples of a fluid are air or another gas and also a liquid. The volume of fluid remaining in the hollow space between the end face of the relay armature and the correspondingly designed end face of the armature return forms a fluid cushion which damps the stopping movement of the end face of the relay armature as it moves into the relay housing and accordingly damps the striking movement, which is produced when contact is made between the end face of the relay armature and the end face of the armature return, by virtue of a reduction in energy.

The denser the volume of fluid within the hollow space between the end face of the relay armature and the end face of the armature return can be kept, the greater the damping effect that can be achieved with the solution proposed according to the invention on account of the low leakage losses. Instead of the V seal between the circumference of the relay armature and the relay housing, it is also possible to form a precise transition fit, for example a H7/g6 fit, in order to keep the leakage losses, that is to say the flow of fluid out of the hollow space between the end faces of the relay armature and the armature return, as low as possible.

In a further variant embodiment for the pneumatic damping of a relay as proposed according to the invention, in particular for operating or for initializing an electrical starting apparatus, the relay armature can contain a longitudinal bore. Said longitudinal bore is connected both to the hollow space between the end face of the relay armature and to the surrounding area. Furthermore, a longitudinal bore, which issues into the hollow space between the end face of the relay armature and the end face of the armature return at one end and into a relief space in the relay housing at the other end, likewise extends through the thickness of the armature return. A valve, for example a non-return valve, can be incorporated in this channel which connects the hollow space to the relief space. If the valve is in the form of a non-return valve, for example, it is oriented in such a way that it closes when the volume of fluid within the hollow space between the end faces of the relay armature and armature return is compressed, and thereby prevents a volume of fluid from flowing out of this hollow space. In one possible variant embodiment of the solution proposed according to the invention, when a valve is provided in the armature return, a main channel, which can be closed by a valve element, and an auxiliary channel, which issues next to the closing element and is always open, for example, issue at the valve seat of said valve. The flow cross sections of the main channel and the auxiliary channel preferably have a size such that the flow cross section of the main channel is larger than the flow cross section of the auxiliary channel. If the volume of fluid in the hollow space between the end face of the relay armature and the end face of the armature return is compressed, the closing element is pushed into the seat and closes the main channel. In accordance with the design of the flow cross section of the auxiliary channel which stays open, the volume of fluid flows out of the hollow space between the end face of the relay armature and the end face of the armature return in a throttled manner, and therefore a volume of fluid which damps the stopping movement of the end face of the relay armature against the end face of the armature return is maintained in the hollow space, this being only partially relieved of pressure into the relief space by means of the auxiliary channel which serves as an outflow channel when the volume of fluid is compressed.

In a further variant embodiment of the solution proposed according to the invention for the pneumatic damping of the relay armature and armature return, by way of example, a guide bush which surrounds a switching pin can be provided with a number of openings, for example transverse bores. These transverse bores allow, depending on the degree of opening of said transverse bores, the volume of fluid to flow out via the openings, depending on the degree of opening of said openings, in the event of a relative displacement with respect to the armature return which is arranged in the relay in a stationary manner. The guide bush serves, depending on the operating path of the switching pin, as a slide, with the volume of fluid flowing out of the hollow space between the relay armature and the armature return of the relay being defined by the degree of opening or degree of overlap of the openings which are formed in the wall filling bush. The volume which flows out of the hollow space between the relay armature and the armature return via the openings in the wall of the guide bush flows into the relief space in the relay.

In a further variant embodiment of the solution proposed according to the invention, when a specific travel movement, that is to say a specific distance ΔS between the end face of the relay armature and the end face of the armature return which is arranged in the relay in a stationary manner, is achieved, a valve can be operated by the end face of the relay armature itself. To this end, a peg-like valve element is provided in the armature return, said valve element being prestressed by means of a spring and being in the closed state as the end face of the relay armature approaches. If the end face of the approaching relay armature strikes an end of the peg-like valve when the distance Δs is reached, said valve is opened as the relay armature gets closer, and therefore fluid flows out of the hollow space, which is defined by the distance Δs, between the end face of the relay armature and the end face of the armature return, which is accommodated in the relay in a stationary manner, only when the distance Δs is reached, and a counterpressure is built up and maintained in order to reach the distance Δs, said counterpressure counteracting the stopping movement of the end face of the relay armature against the end face of the armature return of the relay in a damping manner.

A channel in which the peg-like valve element in the armature return is accommodated can preferably be formed in such a way that said channel is connected to a slot by means of which a volume of fluid flows out of the remaining hollow space, which is defined in accordance with the distance Δs, between the end face of the relay armature and the end face of the armature return when the peg-like valve element is operated by the end surface of the relay armature.

### BRIEF DESCRIPTION OF THE DRAWINGS

The invention will be described in greater detail below with reference to the drawing, in which:

FIG. 1 shows a longitudinal section through a starting apparatus,

FIG. 2 shows a schematic illustration of the relay having a relay armature and an armature return,

FIG. 3 shows a variant embodiment of a valve in the form of a non-return valve,

FIG. 4 shows a guide bush, which acts as slide, in the armature return, accommodated on a switching pin which is not illustrated in FIG. 4,

FIG. 5 shows a V lip formed in a circumferential slot in the relay armature,

FIG. 6 shows a valve which is operated when a distance Δs is reached between the end face of the relay armature and the end face of the armature return which is arranged in the relay armature in a stationary manner, and

FIG. 6.1 shows a section through a channel having a slot in the armature return of the relay.

### DETAILED DESCRIPTION

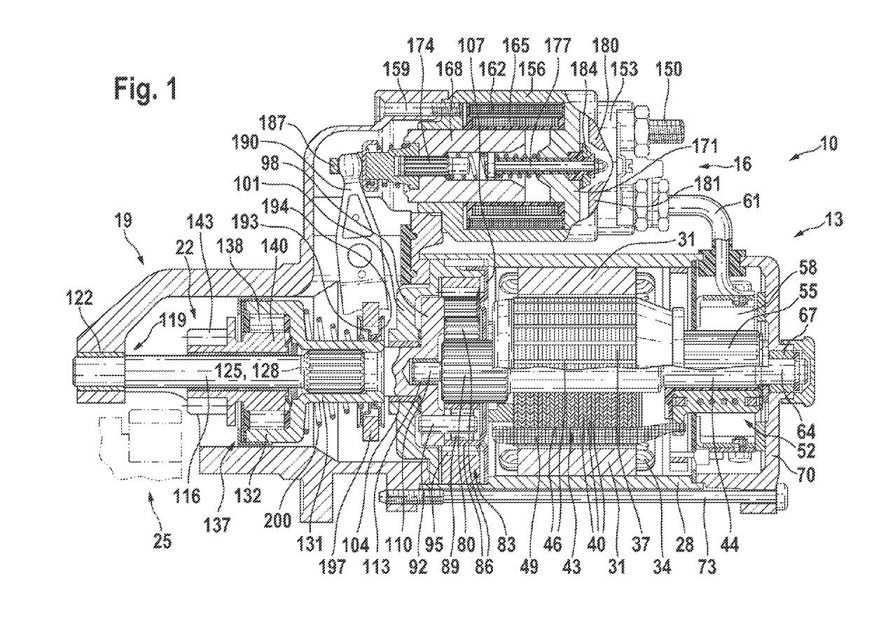

FIG. 1 shows a starting apparatus 10. This starting apparatus 10 has, for example, a starter motor 13 and a relay 16. The starter motor 13 and the relay 16 are attached to a common drive end plate 19. The starter motor 13 has the functional task of driving a starter pinion 22 which is generally in the form of a spur gear. The starter pinion 22 meshes with a ring gear 25 of an internal combustion engine, which is not illustrated in FIG. 1.

The starter motor 13 has, as a housing, a pole tube 28 which has pole shoes 31 on its inner circumference, with a field winding 34 being wound around each of said pole shoes. The pole shoes 31 in turn surround an armature 37, which has an armature stack 43 comprising laminations 40 and an armature winding 49 arranged in slots 46. The armature stack 43 is pressed onto a drive shaft 44. Furthermore, a commutator 52 is fitted at that end of the drive shaft 44 which is remote from the starter pinion 22, said commutator comprising, inter alia, individual commutator laminations 55. The commutator laminations 55 are electrically connected to the armature winding 49, in a known manner, in such a way that, when power is supplied to the commutator laminations 55 by carbon brushes 58, a rotary movement of the armature 37 is produced in the pole tube 28. A power supply line 61 which is arranged between the meshing relay 16 and the starter motor 13 supplies power to both the carbon brushes 58 and the field winding 34 in the switched-on state. The drive shaft 44 is supported on the commutator side by a shaft journal 64 and a sliding bearing 67 which in turn is held fixed in position by a commutator bearing cap 70. The commutator cap 70 is in turn fixed in the drive end plate 19 by means of tension rods 73, which are arranged distributed over the circumference of the pole tube 28 (screws, for example two, three or four pieces). In the process, the pole tube 28 is supported on the drive end plate 19, and the commutator bearing cap 70 is supported on the pole tube 28.

In the drive direction, the armature 37 is adjoined by a sun gear 80, which is part of a planetary gear mechanism 83. The sun gear 80 is surrounded by a plurality of planet gears 86, usually three planet gears 86, which are supported by means of roller bearings 89 on axle journals 92. The planet gears 86 roll in a hollow wheel 95, which is mounted externally in the pole tube 28. In the direction toward the output drive side, the planet gears 86 are adjoined by a planet carrier 98, in which the axle journals 92 are accommodated. The planet carrier 98 is in turn mounted in an intermediate bearing 101 and a sliding bearing 104 which is arranged therein. The intermediate bearing 101 is configured in the form of a pot in such a way that both the planet carrier 98 and the planet gears 86 are accommodated in said intermediate bearing. Furthermore, the hollow wheel 95 is arranged in the pot-shaped intermediate bearing 101 and is ultimately closed by a cover 107 with respect to the armature 37. The intermediate bearing 101 is also supported by way of its outer circumference on the inner face of the pole tube 28. The armature 37 has a further shaft journal 110 on that end of the drive shaft 44 which is remote from the commutator 52, said shaft journal likewise being accommodated in a sliding bearing 113. The sliding bearing 113 is in turn accommodated in a central bore in the planet carrier 98. The planet carrier 98 is integrally connected to the output drive shaft 116. This output drive shaft 116 is supported by its end 119 which is remote from the intermediate bearing 101 in a further bearing 122, the A bearing, which is formed in the drive end plate 19. The output drive shaft 116 is divided into various sections: a section with a straight gearing 125 (inner gearing) which is part of a shaft-hub connection 128 thus follows the section which is arranged in the sliding bearing 104 of the intermediate bearing 101. This shaft-hub connection 128 makes it possible in this case for a driver 131 to perform an axially linear sliding movement. This driver 131 is a sleeve-like protrusion, which is integral with a pot-shaped outer ring 132 of the freewheel 137. This freewheel 137 (ratchet) furthermore comprises the inner ring 140, which is arranged radially within the outer ring 132. Clamping bodies 138 are arranged between the inner ring 140 and the outer ring 132. The clamping bodies 138, in interaction with the inner and the outer ring, prevent a relative movement between the outer ring and the inner ring in a second direction. The freewheel 137 allows a relative movement between the inner ring 140 and the outer ring 132 in only one direction. In this exemplary embodiment, the inner ring 140 is integrally formed with the starter pinion 22 and the helical gearing 143 (outer helical gearing) thereof.

The relay 16 has a pin 150, which constitutes an electrical contact and is connected to the positive terminal of an electrical starter battery (not illustrated in FIG. 1). This pin 150 is passed through a relay cover 153. This relay cover 153 closes off a relay housing 156, which is fastened to the drive end plate 19 by means of a plurality of fastening elements 159 (screws). A pull-in winding 162 and a holding winding 165 are furthermore arranged in the relay 16. The pull-in winding 162 and the holding winding 165 both each induce an electromagnetic field in the switched-on state, said electromagnetic field flowing through both the relay housing 156 (composed of electromagnetically conductive material), a linearly moving armature 168 and an armature return 171. The armature 168 has a push rod 174, which is moved in the direction of a switching pin 177 during linear pull-in of the armature 168. With this movement of the push rod 174 toward the switching pin 177, said switching pin is moved out of its rest position in the direction toward two contacts 180 and 181, so that a contact bridge 184, which is fitted at the end of the switching pin 177, electrically connects the two contacts 180 and 181 to one another. As a result, electrical power is passed from the pin 150, beyond the contact bridge 184, to the power supply line 61 and therefore to the carbon brushes 58. Power is supplied to the starter motor 13 in the process.

However, the relay 16 and the armature 168 furthermore also have the task of moving, with a pull element 187, a lever which is arranged in the drive end plate 19 such that it can rotate. The lever 190, usually in the form of a forked lever, engages with two “prongs” (not shown here) on its outer circumference around two disks 193 and 194 in order to move a driver ring 197, which is trapped between said disks, toward the freewheel 137 counter to the resistance of the spring 200 and thereby to mesh the starter pinion 22 with the ring gear 25 of the internal combustion engine.

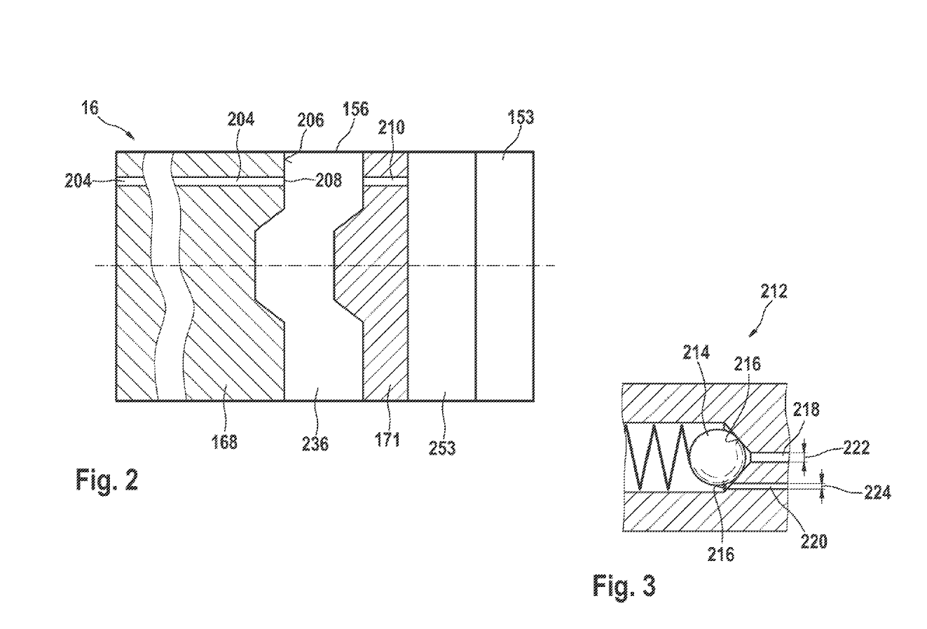

FIG. 2 shows a schematic section through the relay for operating the starting apparatus according to FIG. 1 on an enlarged scale.

The illustration according to FIG. 2 shows a relay for operating an electrical starting apparatus on an enlarged scale.

FIG. 2 shows that the relay 16 has a linearly moving armature, that is to say a relay armature 168, the end face 206 of said armature corresponding to the end face of the armature return 171 which is accommodated in the relay housing 156. A hollow space 236, which is filled with a fluid, for example air, is formed between the end face 206 and that end face of the armature return 171 which is situated opposite said end face 206. A channel 204 which issues at a mouth 208 in the end face 206 of the relay armature 168 passes through the relay armature.

A channel 210 likewise passes through the armature return 171, a valve, which is illustrated on an enlarged scale in FIG. 3, for example in the form of a non-return valve 212, being accommodated in said channel.

Both the channel 204 in the relay armature 168 and the channel 210 in the armature return 171 have a diameter of only a few mm. The channel 204 in the relay armature 168 extends from the mouth 208, runs through the relay armature 168, and issues in the external area surrounding the relay 16.

The channel 210, which passes through the armature return 171, connects the hollow space 236 to a relief space 253 on that side of the armature return 171 which is averted from the relay armature 168 and is accommodated in the relay housing 156 of the relay 16 in a stationary manner. Reference symbol 153 denotes a relay cover of the relay 16.

FIG. 3 shows a valve which is in the form of a non-return valve 212 and is arranged in the channel 210 of the armature return 171. A spring-loaded, in this case spherical, closing element 214 is provided in the valve 212 which is in the form of a non-return valve, said closing element being pushed by the spring into a seat 216 which is formed in the armature return 171. Both a main channel 218, which has a first diameter D₁, compare reference symbol 220, and an auxiliary channel 220, which has a smaller, second diameter D₂, compare item 224, extend from the seat 216 of the valve 212. While the main channel 218 is closed when the closing element 214 is in its seat 216, this is not the case for the auxiliary channel 220 which is still permeable but has a second, smaller diameter D₂, compare item 224, than the first diameter D₁, compare item 222 of the main channel 218, in the closed state of the closing element 214.

In the variant embodiment of a pneumatic damping arrangement illustrated in FIGS. 2 and 3, the volume of fluid which is contained in the hollow space 236 is compressed as the end surface 206 approaches in the event of a linear movement of the relay armature 168 in the direction of the end face of the armature return 171. As a result, the energy of the relay armature 168 which is moving toward the armature return 171 is reduced. On account of the build-up of pressure, the non-return valve 212 closes the seat 216 and therefore the main channel 218, while a flow of fluid through the auxiliary channel 200, which is not closed by the closing element 214 and issues into the relief space 253, can be reduced. This results in a gradual reduction in pressure in the hollow space 236, with the pressure level, however, being kept at a level such that the end surface 206 of the relay armature which is moving toward the armature return 171 does not come to a hard stop and the development of noise due to hard contact between the metals of the end surface 206 at that end surface of the relay armature 171 which corresponds to said end surface 206 is precluded.

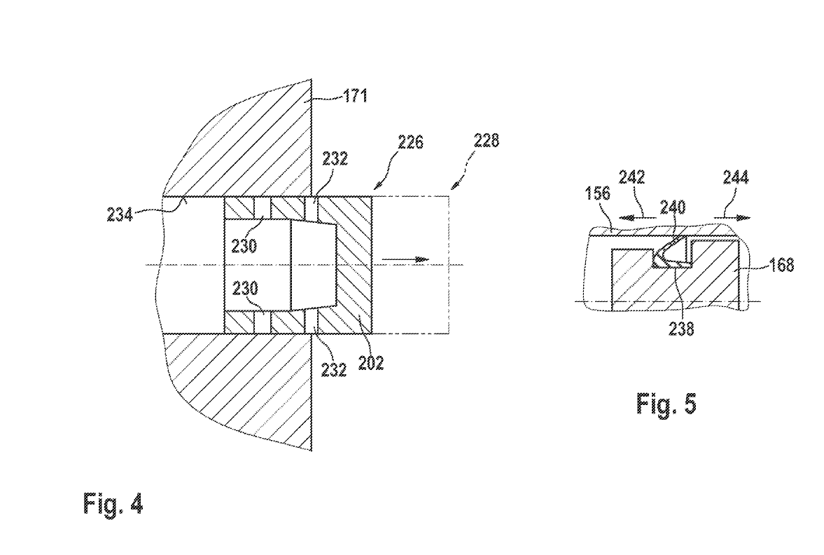

The illustration according to FIG. 4 shows that hydraulic damping can also be achieved by a guide bush, which is accommodated on the switching pin 177, in this variant embodiment.

In this variant embodiment, compare the illustration according to FIG. 1, the guide bush 202, which is accommodated on the switching pin 177, is provided with a number of openings 230 and 232 which can be in the form of, for example, transverse bores which run through the wall of the guide bush 202.

In the illustration according to FIG. 4, the guide bush 202 having openings, which are in the form of transverse bores 230 and 232, is placed in a first position 226 which is indicated by solid lines. If, as shown in the illustration according to FIG. 2, the relay armature 168 moves by way of its end face 206 into the hollow space 236 in the relay housing 156 of the relay 16, the volume of fluid present in said hollow space will be compressed. The switching pin 177, which is not illustrated in FIG. 2 but is illustrated in FIG. 1, moves into the armature return 171, so that the guide bush 202 which is accommodated on said switching pin is moved from the first position 226, which is illustrated in FIG. 4 and indicated by solid lines, to its second position 228, which is indicated by dashed lines. During this movement into the relief space 253, the openings 230 in the wall of the guide bush 202 are fully or partially exposed, so that a connection is created between the hollow space 236 and the relief space 256 within the relay housing 156. Depending on the design of the cross sections and the number of openings in the wall of the guide bush 202, compressed fluid flows out of the hollow space 236 and into the relief space 253. The contact between the end face 206 of the relay armature 168 and the end face of the armature return 171 is pneumatically damped by virtue of this gradual reduction in pressure in the hollow space 236 and by virtue of compressed fluid flowing out of the hollow space 236 and into the relief space 253 in a controlled manner.

The illustration according to FIG. 5 shows a further variant embodiment of a pneumatic damping arrangement of a relay.

In this variant embodiment, the armature 168, which is only indicated in FIG. 5, is provided with a circumferential slot 238 or a recess over its circumference. In the illustration according to FIG. 5, the circumferential slot 238 is approximately square and has a V lip 240 arranged in it.

The V lip 240 has a limb which engages against the wall of the relay housing 156. If the relay armature 168 moves in the second movement direction 244, the upper limb of the V lip 240 will engage against the wall of the relay housing 156, so that damping in respect of the relay armature 168 is provided in a manner dependent on the movement direction. If, in contrast, the relay armature 168 is moved in the first movement direction 242, the volume of fluid enclosed in the hollow space 236 will be relieved of pressure.

The variant embodiments of a pneumatic damping arrangement according to FIGS. 2, 3 4 and 5 can be used to provide direction-dependent pneumatic damping if the relay armature 168 moves, by way of its end face 206, into the hollow space 236, the volume of fluid which is contained in said hollow space is compressed, and a gradual reduction in pressure is initiated in the hollow space 236 or, compare the illustration according to FIG. 5, the hollow space 236 is sealed off from pressure loss, so that the development of noise when the end face 206 of the relay armature 168 stops against that end face of the armature return 171 which is accommodated in the relay housing 156 in a stationary manner is significantly damped.

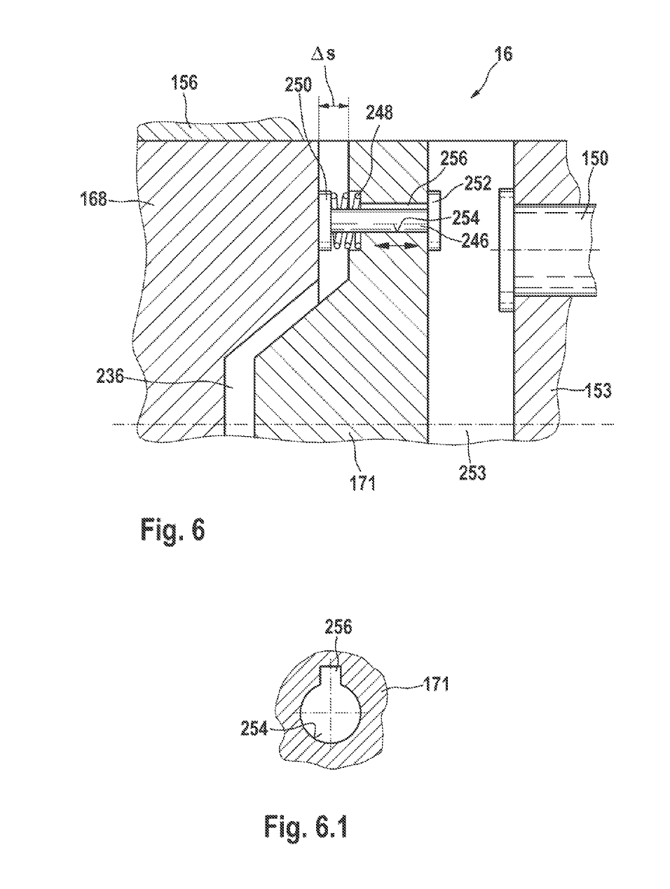

The illustrations according to FIGS. 6 and 6.1 show a further variant embodiment of the pneumatic damping arrangement proposed according to the invention.

If the end face 206 of the armature 168 has reached a distance Δs from the end face of the armature return 171, a valve element 246 is operated. The valve element 246, which is in the form of a peg in this case and which is accommodated in a channel 254 such that it can move, is operated by a valve stop 250 stopping against the end of the peg-like valve element 246. A head 252 of the valve element 246 is moved into the relief space 253 against the action of the spring force of the valve spring 248, so that a slot 256 is exposed, volumes of fluid flowing out of the hollow space 236 which is defined by the distance Δs and into the relief space 253 via said slot.

The valve which is illustrated in the illustration according to FIG. 6 responds only when a well-defined distance Δs between the end face 206 of the relay armature 168 and the end face of the armature return 171, which is designed to have a geometry which corresponds to said end face of the relay armature, is reached.

For the sake of completeness, it should be mentioned that reference symbol 150 denotes the pin by means of which power is supplied to the relay 16.

The illustration according to FIG. 6 shows that the slot 256 in the armature return 171 runs, for example, above the actual channel 254 in the material of the armature return 171. The slot 256 can also be formed at the 3 o'clock, 6 o'clock or 9 o'clock position or any other desired defined position in respect of the illustration according to FIG. 6.1.

The valve element 246 which is illustrated in the illustration according to FIG. 6 opens only when a well-defined distance Δs between the components relay armature 168 and the armature return 171, which is arranged in the relay housing 156 in a stationary manner, is reached.

1. A relay (16), having a relay armature (168) and an armature return (171), characterized in that a volume of fluid, which is enclosed in a hollow space (236, Δs), between the relay armature (168) and the armature return (171) pneumatically damps the movement of the relay armature (168) in the direction of the armature return (171).

2. The relay (16) as claimed in claim 1, characterized in that the relay armature (168) has, in a circumference of the armature, a damping element (240) which is operated in a manner dependent on a movement direction.

3. The relay (16) as claimed in claim 1, characterized in that a valve (212), which is acted on in a closing direction by compression of the fluid in the hollow space (236), is located in one of the armature return (171) and the relay armature (168).

4. The relay (16) as claimed in claim 3, characterized in that the hollow space (236, Δs) is relieved of pressure by an auxiliary channel (220) when the valve (212) is closed.

5. The relay (16) as claimed in claim 3, characterized in that the hollow space (236, Δs) is refilled with fluid by a main channel (218) and an auxiliary channel (220), which both issue into a seat (216) of the valve (212), when the valve (212) is open.

6. The relay (16) as claimed in claim 1, characterized in that the hollow space (236, Δs) is configured to be relieved of pressure by a guide bush (202) having at least one opening (230, 232).

7. The relay (16) as claimed in claim 1, characterized in that a valve element (246) which relieves the hollow space (236) of pressure is operated when a distance Δs between the relay armature (168) and the armature return (171) is reached.

8. The relay (16) as claimed in claim 7, characterized in that the valve element (246) is located in the armature return (171).

9. The relay (16) as claimed in claims 7, characterized in that the armature return (171) comprises a channel (254) in which the valve element (246) is guided, and also a slot (256) which issues into a relief space (253).

10. The relay (16) as claimed in claim 1, characterized in that the pneumatic damping is damping, which is dependent on the movement direction, in respect of the relay armature (168) approaching the armature return (171).

11. The relay (16) as claimed in claim 1, characterized in that at least one of the relay armature (168) and the armature return (171) has a channel (204, 210) for throttled deaeration of the hollow space (236).

12. The relay (16) as claimed in claim 1, characterized in that a sealing element (240), between the relay armature (168) and the relay housing (156) seals off the hollow space (236).

13. The relay (16) as claimed in claim 1, characterized in that the relay is for electrical starter apparatuses for internal combustion engines.

14. The relay (16) as claimed in claim 3, characterized in that the valve (212) is a non-return valve.

15. The relay (16) as claimed in claim 12, characterized in that the sealing element (240) is a sealing lip or a sealing ring.
